(19) United States
(12) Patent Application Publication
(10) Pub. No.: US 2005/0183414 A1
(43) Pub. Date: Aug. 25, 2005

(54) Exhaust manifold

(76) Inventors: Wilfried Bien, Seevetal-Emmelndorf (DE); Pierre Bonny, Hamburg (DE); Markus Brown, Hattenhofen (DE); Thomas Hulsberg, Buchholz (DE); Uwe Klussmann, Bispingen (DE); Norbert Kreutzig, Hamburg (DE); Holger Nuhn, Schneverdingen (DE); Ralf Punjer, Seevetal/Fleestedt (DE); Olav Reinhardt, Hamburg (DE); Thorsten Sternai, Moisburg (DE)

Correspondence Address: PENDORF & CUTLIFF, 5111 MEMORIAL HIGHWAY, TAMPA, FL, 33634-7356, US

(21) Appl. No.: 11/022,104

(22) Filed: Dec. 23, 2004

(30) Foreign Application Priority Data
Dec. 23, 2003 (DE) 103 60 645.9

(51) Int. Cl. F01N 7/10; F02B 31/00

(52) U.S. Cl. 60/323

(57) ABSTRACT

An exhaust manifold for connecting an exhaust pipe with at least one cylinder of an internal combustion engine, and a shell manifold as at least one component of the exhaust manifold. The at least one shell manifold (3, 9, 17, 31, 38) is comprised of at least two shape shells (4, 14, 10, 20, 18, 28, 32, 34, 39). The shape shells are joined to each other by mechanical interlocking. The shell manifold exhibits at least one inlet (5, 11, 19, 35, 46). The shell manifold (3, 9, 17, 31, 38) is so designed, that the at least one inlet (5, 11, 19, 35, 46) communicates with the at least one cylinder.

### BACKGROUND OF THE INVENTION

1. Field of the Invention

The invention concerns an exhaust manifold for connecting an exhaust with at least one cylinder of an internal combustion engine, and a shell manifold as at least one component of the exhaust manifold.

2. Related Art of the Invention

Exhaust manifolds are used in motor vehicles with internal combustion engines as conduits for removal of exhaust gasses produced during combustion in the cylinders of the internal combustion engine. These exhaust manifolds are, in general, pipe-shaped and can be subdivided or, as the case may be, branched in various manners into pipe segments.

Exhaust manifolds in general have a number of inlets corresponding to the number of cylinders in the internal combustion engine, wherein each of these inlets is connected with a respective cylinder, for example via a flange as connecting piece. In this type of exhaust manifold these inlets, connected with the cylinders of the internal combustion engine, are connected into a so-called main line or collecting line. An outlet of this main line can be connected via a flange with an exhaust pipe. The exhaust gases produced in the cylinders are accordingly conveyed from the outlets associated with the cylinders, through the main line and through the outlet leading from the main line into the exhaust pipe.

For producing this type of exhaust pipe various processes are known. For example, the so-called IHU technique can be employed. However, this is expensive and labor intensive, which can lead to relatively high construction prices.

In the document DE 199 28 276 C2 an exhaust manifold is described, which is connected via a flange with the collector associated with the exhaust pipe. Various separate pipe pieces are connected to this collector, which respectively produce one connection of the collector with respectively one cylinder. The collector is comprised of two sheet metal parts, which are plugged into each other and secured by clamps or clips. The entire device comprised of the collector and the therefrom outgoing pipe pieces is surrounded by a cover shell or jacket. In this design of exhaust manifold with purely mechanically connected shaped parts from conveyance away of exhaust gas there may in certain circumstances be a failure of the exhaust gas system, since the high exhaust gas temperatures and the pulsations can cause a melting or yielding of the material at the mechanical clamp locations. Over a long period of operation there could thus result a loosening of the connections and the generation of rattling noises.

### SUMMARY OF THE INVENTION

With this as the background, the invention is concerned with the design of an improved exhaust manifold.

For this an exhaust manifold with the characteristics of Patent claim 1 and a shell manifold with the characteristics of Patent claim 14 are provided.

The inventive exhaust manifold for connecting an exhaust pipe with at least one cylinder of an internal combustion engine includes at least one shell manifold, wherein the at least one shell manifold is comprised of at least two shape shells joined to each other by mechanical shape locking or interlocking. Therein it is envisioned that the at least one shell manifold includes at least one outlet. The shell manifold of the inventive exhaust manifold is so designed, that the at least one inlet opens into the at least one cylinder. Therewith a particularly compact manner of construction of the at least one shell manifold or, as the case may be, exhaust manifold is realized. The at least one shell manifold exhibits thereby a particularly high stability. By this manner of construction it becomes possible to dispense with pipe pieces as required for example according to the document DE 199 28 276 C2. A minimization of individual pieces in this manner brings about for example also an optimization of the fabrication or manufacture of the exhaust manifold.

The at least one inlet of the at least one shell manifold of the inventive exhaust manifold can be secured to the cylinder via at least one cylinder associated flange. Therein the at least one inlet of the at least one shell manifold can be connected to the flange by welding. A particularly gas-tight securing of the at least one shell manifold to the flange is also possible in any other suitable connecting means. The flange, for its part, is preferably sealed gas-tight to the cylinder.

The mechanical form-fitting or interlocking can be accomplished by clamping, riveting, clips, pressing, crimping, folding and creasing, or by other suitable mechanical joining means, via which the two shape shells are joined to each other.

The edges of two adjacent form shells to be joined to each other can be, for example, meandering or zigzagging. This type of edging can, as a result of its structure, interlock or interdigitate, which increases the stability or rigidity of the form fitting connection provided in accordance with the invention.

The two shape shells, after successful mechanical form fitting, preferably pressure fitting, are joined in partial areas by means of resistance welding or resistance soldering or brazing. In general, for this type of joining any of the thermal, electronic as well as thermal-electronic joining means which are suitable for joining two component parts of metal can be employed. This joining can, depending upon type of joint, be point-shaped, however also be in segments as a seam or elongated weld. This serves for supplemental securing or joining of the joint between the two shape shells, which can be realized in simple and economical manner.

If it is for example the case, that the exhaust manifold is formed of two shell manifolds, then one of the shell manifolds can be inserted into the other shell manifold. Therein the exhaust side outlet of the first shell manifold is joined with the motor side inlet of an adjacent second shell manifold. In a design or arrangement of this type temperature dependent changes in length of the exhaust manifold can be compensated thereby, that adjacent shell manifolds are joined into each other by a simple slide seat. Therein it is provided, that the exhaust side outlet of the first shell manifold is slid upon the motor side outlet of the second shell manifold, so that the motor side inlet surrounds the exhaust side outlet, or encompasses or incases this.

For realizing the slide joint or seat the one shell manifold can be widened at the motor side inlet and/or the other shell manifold can be narrowed at the exhaust side outlet. In an alternative embodiment of the invention it is envisioned that the one shell manifold has a greater diameter then the other shell manifold into which is to be slidingly inserted.

An advantage of the invention is comprised therein, that the shell manifold or as the case may be exhaust manifold can be produced economically. In certain embodiments the number of the components can be substantially reduced in comparison to known exhaust manifolds. Therein it can be provided, that the exhaust manifold essentially comprises one shell manifold. This one shell manifold possesses a number of motor-facing inlets corresponding to the number of cylinders, and an exhaust side outlet. It is of course possible that the exhaust manifold has any desired number of shell manifolds.

The shell manifolds can for example be T-shaped. In a particularly simple embodiment a shell manifold is a bent pipe piece with essentially two openings, namely one inlet and one outlet. A pipe piece of this kind can for its part be comprised of two shape shells joined to each other by mechanical form-interlocking:

In a preferred embodiment of the invention it is envisioned that the at least one shell manifold is a gas conveying inner part, which is encased or encompassed by an outer shell. Therewith the at least one shell manifold is shielded gas tight against the environment. The shell, which surrounds the at least one shell manifold, is gas tight. Further, in a preferred embodiment an air gap is provided between the one shell manifold and the outer shell. An exhaust manifold provided in this manner is an air-gap insulated exhaust manifold.

The inventive shell manifold is at least one component of an exhaust manifold for connecting the exhaust system with at least one cylinder of an internal combustion engine. This shell manifold is comprised of at least two shape shells joined to each other by mechanical form interlocking, and exhibits at least one inlet. Therein the inventive shell manifold is so designed, that the at least one inlet opens in to the at least one cylinder.

In accordance with the invention an exhaust manifold is provided, which is reliably form stable even under thermal as well as under mechanical stresses.

Further advantages and embodiments of the invention can be seen from the description and the associated figures.

It is understood that the characteristics described above and in the following are not limited to the respectively described combinations, but rather can be used in other combinations or alone, without leaving the scope of the present invention.

### BRIEF DESCRIPTION OF THE DRAWING

The invention is shown schematically in the figures using an illustrative embodiment and will be described in greater detail in the following with reference to the figures.

FIG. 1 shows a preferred embodiment of the inventive exhaust manifold in a first schematic representation.

FIG. 2 shows an inventive exhaust manifold in a preferred embodiment in a second schematic representation.

FIG. 3 shows a first embodiment of an inventive shell manifold during manufacture in schematic representation.

FIG. 4 shows a second embodiment of an inventive shell manifold in schematic representation.

FIG. 5 shows a third embodiment of an inventive shell manifold in schematic representation.

### DETAILED DESCRIPTION OF THE INVENTION

The figures are described in association with each other and overlapping. The same reference number means the same element.

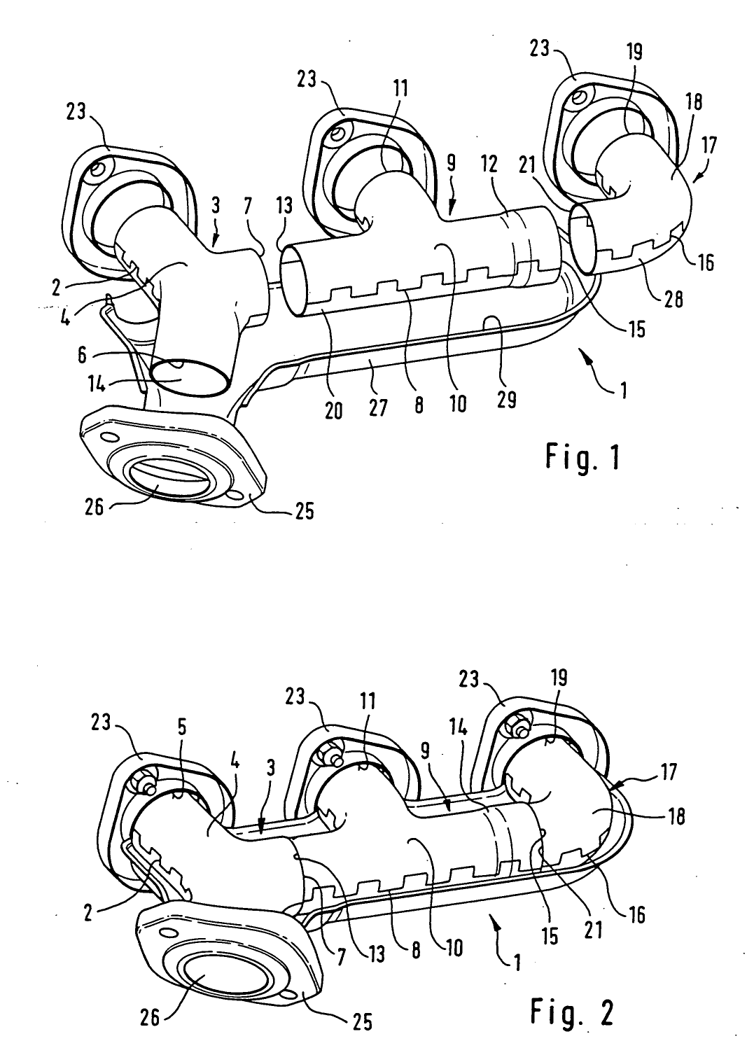

The exhaust manifold 1 represented schematically in FIG. 1 is comprised of three shell manifolds 3, 9, 17. The first shell manifold 3 exhibits three pipe-like openings, namely, an outlet 6 as well two inlets 5, 7. A first inlet 5 is secured via a flange 23 to a first cylinder of a not shown internal combustion engine, so that the inlet 5 opens directly into this cylinder. A joining or securing of this type can be provided by welding.

The outlet 6 of the first shell manifold 3 is directed towards an exhaust or a catalytic converter. For compensation of thermal expansion, which occurs as a result of operation of the internal combustion engine, it is provided, that the outlet 6 is provided moveably in an opening 26 of a flange 25, which is secured to an exhaust type or as the case may be a catalytic converter. The first shell manifold 3 is connected with the second shell manifold 9 via a further inlet 7. This second shell manifold 9 also exhibits an outlet 13 as well two inlets 11, 15 and it is provided, that the outlet 11 is secured for example via a flange 23 to a second cylinder of the internal combustion engine, that is opens into this cylinder.

The outlet 13 of the second shell manifold 9 is inserted into the inlet 7 of the first shell manifold 3. This can be made possible thereby, that the cross-section or as the case may be diameter of the second shell manifold 9 is smaller than the cross-section or as the case may be diameter of the first shell manifold 3. Thereby a sliding joint is provided between the first shell manifold 3 and the second shell manifold 9, whereby thermal induced expansions of the shell manifold or as the case may be exhaust manifold can be compensated.

The second inlet 15 of the second shell manifold 9 is in this embodiment provided with a widening 12. By this widening 12 it becomes possible to slidingly insert the outlet 21 of a third shell manifold 17 into the inlet 15 of the second shell manifold 9, so that a sliding seat between the two shell manifolds 9, 17 is provided. Besides this the third shell manifold 17 is secured with its inlet 19 against a third cylinder of the internal combustion engine. This securing can occur via a flange 23, so that this inlet 19 opens into the third cylinder.

It is provided in accordance with the invention that each of the three shell manifolds 3, 9, 17 is comprised of respectively two form shells 9, 10, 14, 20, 18, 28.

In the first shell manifold 3 one can see, besides the upper shape shell 4, also part of the lower shape shell 14. These two shape shells 4, 14 are inter-connected or joined by their mechanical shape, wherein the joining occurs along a meandering joint seam 2.

Further, in the case of the second shell manifold 9 one can see, besides the upper shape shell 10, also in part the lower shape shell 20. These shape shells 10, 20 are also joined to each other by mechanical form interlocking along a meandering joint seam 8.

Likewise, the third shell manifold 17 includes two shape shells 18, 28, which are joined to each other via mechanical form fitting and abut along a meandering joint gap 16.

Besides this one can see in FIG. 1 a lower partial shell 27 with a crimped or flanging or as the case may be bent over edge 29, in which the three shell manifolds 3, 9, 17 are to be embedded (FIG. 2). Upon this lower partial shell 27 a second partial shell is to be seated which is shaped mirror symmetrically substantially with regard to the edge 29, so that the three shell manifolds 3, 9, 17 in their assembled condition are surrounded or encompassed by a shell.

FIG. 2 shows an exhaust manifold 1 in an assembled condition.

The inventive form fitting between respectively two shape shells 4, 14, 10, 20, 18, 28 is shown in this embodiment on the basis of a meandering shaped joint seam 2 along the first shell manifold 3 between the shape shells 4 and 14, a corresponding joint seam 8 between the shape shells 10 and 20 along the second shell manifold 9 as well as a corresponding joint seam 16 between the shape shells 18 and 28 along the third shell manifold 17. In this representation one can recognize respectively only the upper shape shells 4, 10, 18 respectively of the three shell manifolds 3, 9, 17. The lower form shells 14, 20, 28 are surrounded by a partial shell 27, this partial shell 27 exhibits a flange or as the case may be bent edge 29.

It is further shown in FIG. 2 how the inlets 5, 11, 19 of the shell manifolds 3, 9, 17 are secured to the flanges 23. These flanges 23 are provided on a here not shown cylinder of a internal combustion engine, so that these inlets 5, 11, 19 open into these cylinders.

FIG. 3 shows a second shell manifold 9 in a condition prior to connecting the two shape shells 10, 20 with each other. Thereby a meandering edge 8a of the upper shape shell 10 is shown representing also a meandering shaped edge 8b of the lower shape shell 20. Further a exhaust side partial outlet 13a of the upper shape shell 10 as well as an exhaust side partial outlet 13b of the lower shape shell is recognizable. The upper shape shell 10 exhibits a motor facing partial inlet 15a, the lower shape shell 20 exhibits a motor facing partial inlet 15b.

After the joining of the two shape shells 10, 20 by mechanical shape interlocking, for forming the second shell manifold 9, the edges 8a, 8b lie against each other and form therewith the joint seam 8. The two exhaust side partial outlets 13a, 13b form the exhaust side outlet 13. In the same way the two motor side partial inlets 15a, 15b form the motor side inlet 15 of the second shell manifold 9.

FIG. 4 shows a shell manifold 31, which, like the shell manifold 9, is substantially in the shape of a T. This shell manifold 31 includes an upper shape shell 32 and a lower shape shell 34, which are joined by mechanical form fitting engagement according to the invention. These two shape shells 32, 34 abut along the joint seam 30. The shell manifold 31 has an exhaust pipe side outlet 33 as well as two motor side inlets 35, 37. Thereby it can be provided, that the inlet is connected with the outlet of a cylinder of the internal combustion engine via a flange. The exhaust side outlet 33 can either open or communication into a motor facing inlet of an adjacent shell manifold or it can be provided, that the exhaust pipe facing outlet 33 opens into a flange, via which the shell manifold 31 is connected with the exhaust pipe. The motor side inlet 37 exhibits on the basis of the widening 36 a large diameter, so that it is possible to slide an exhaust directed outlet of an adjacent located shape manifold into the motor side inlet of the shell manifold 31.

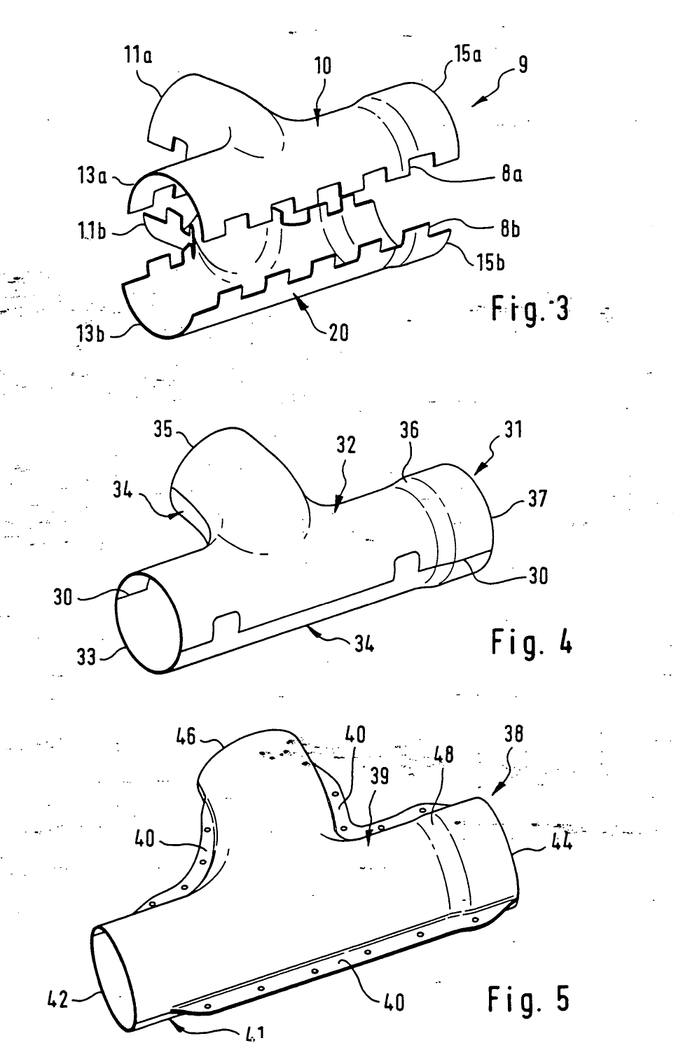

FIG. 5 shows an upper shape shell 39 of a likewise substantially T-shaped shell manifold 38, which exhibits an exhaust side outlet 42 as well as two motor side inlets 44, 46, wherein the motor side inlet 44 exhibits on the basis of a widening 48 a greater diameter than the exhaust side outlet 42. Besides this a lower shape shell 41 of the shell manifold 38 is partially recognizable. The upper shape shell 39 exhibits a flanged edge 40, to which a correspondingly shaped edge of the lower shape shell 41 is laid against. These two edges of these two shape shells 39, 41 are joined along these two edges by mechanical form locking. Thereby it can be provided, that the two shape shells 39, 41 are spot welded, soldered, pressed or riveted along the edge.

1. An exhaust manifold for connecting an exhaust system with at least one cylinder of an internal combustion engine, which includes at least one shell manifold (3, 9, 17, 31, 38), wherein the at least one shell manifold (3, 9, 17, 31, 38) is comprised of at least two shape shells (4, 14, 10, 20, 18, 28, 32, 34, 39) shape shells being joined to each other by mechanical interlocking, and exhibits at least one inlet (5, 11, 19, 35, 46), wherein the shell manifold (3, 9, 17, 31, 38) is so designed, that the at least one inlet (5, 11, 19, 35, 46) communicates with the at least one cylinder.

2. The exhaust manifold according to claim 1, wherein the at least one shell manifold (3, 9, 17, 31, 38) is adapted to be secured to at least one cylinder.

3. The exhaust manifold according to claim 1, in which the at least one shell manifold (3, 9, 17, 31, 38) is adapted to be secured via a flange (23) associated with the at least one cylinder.

4. The exhaust manifold according to claim 1, in which the at least one shell manifold (3, 9, 17, 31, 38) is secured by welding.

5. The exhaust manifold according to claim 1, in which the at least two shape shells (4, 14, 10, 20, 18, 28, 32, 34, 39) of the at least one shell manifold (3, 9, 17, 31, 38) are joined to each other by clamping.

6. The exhaust manifold according to claim 1, in which the at least two shape shells (4, 14, 10, 20, 18, 28, 32, 34, 39) of the at least one shell manifold (3, 9, 17, 31, 38) are joined to each other by crimping.

7. The exhaust manifold according to claim 1, in which the at least two shape shells (4, 14, 10, 20, 18, 28, 32, 34, 39) of the at least one shell manifold (3, 9, 17, 31, 38) are joined to each other by riveting.

8. The exhaust manifold according to claim 1, in which the at least two shape shells of the at least one shell manifold (3, 9, 17, 31, 38) are joined to each other by clamping.

9. The exhaust manifold according to claim 1, in which the at least two shape shells (4, 14, 10, 20, 18, 28, 32, 34, 39) of the at least one shell manifold (3, 9, 17, 31, 38) are additionally spot joined by a thermal joining process.

10. The exhaust manifold according to claim 1, comprising at least two shell manifolds (3, 9, 17, 31, 38), wherein one of the shell manifolds (3, 9, 17, 31, 38) is inserted into the other shell manifold (3, 9, 17, 31, 38).

11. The exhaust manifold according to claim 1, in which the at least one shell manifold (3, 9, 17, 31, 38) is a gas channeling or guiding inner part, which is enclosed by an outer shell (27).

12. The exhaust manifold according to claim 11, in which the outer shell (27) enclosing the at least one shell manifold (3, 9, 17, 31, 38) is gas-tight.

13. The exhaust manifold according to claim 1, in which an air gap is provided between the outer shell (27) enclosing the at least one shell manifold (3, 9, 17, 31, 38) and the at least one shell manifold (3, 9, 17, 31, 38).

14. A shell manifold as at least one component of an exhaust manifold (1) for connecting an exhaust pipe with at least one cylinder of an internal combustion engine, which is comprised of at least two shape shells (4, 14, 10, 20, 18, 28, 32, 34, 39) joined to each other by mechanical form interlocking, exhibiting at least one inlet (5, 11, 19, 35, 46) and so designed, that the at least one inlet (5, 11, 19, 35, 46) opens into the least one cylinder.

15. The shell manifold according to claim 14, adapted to be a gas channeling inner part of an air gap insulated exhaust manifold (1).
